(19) United States
(12) Patent Application Publication
(10) Pub. No.: US 2022/0080563 A1
(43) Pub. Date: Mar. 17, 2022

(54) Jointed Wrench

(71) Applicant: A & E INCORPORATED, Racine, WI (US)

(72) Inventors: Jeffrey J. Kuzmic, Wind Lake, WI (US); Buce J. Engel, Milwaukee, WI (US); Billy Greuel, Waterford, WI (US)

(73) Assignee: A & E INCORPORATED, Racine, WI (US)

(21) Appl. No.: 17/018,312

(22) Filed: Sep. 11, 2020

(51) Int. Cl. B25B 23/00; B25B 13/48; B25B 13/46

(52) U.S. Cl. CPC B25B 23/0028; B25B 23/0035; B25B 13/463; B25B 13/481

(57) ABSTRACT

The present invention relates to a jointed wrench. A multi-directional knuckle in a midsection or handle of the wrench allows for multiple angles created in the handle of the wrench. This allows a user to manipulate a ratcheting portion of the wrench into otherwise inconvenient spaces, such as an interior of an automobile engine compartment.

In another aspect of the present invention, a locking ring is paired with a fine tooth wheel within a ratchet, and the locking ring couples with locking detented sockets or adaptors.

### BACKGROUND OF THE INVENTION

Wrenches, specifically ratcheting wrenches are well known to those in the art. Generally, most ratcheting wrenches consist or a gear with teeth and a spring-loaded finger, or pawl making contact with the teeth. By the internal mechanics of these types of ratcheting wrenches, as the gear rotates in an unrestricted direction the pawl rides along the teeth and when it passes over a tooth the spring will force the pawl back in contact with the gear. This creates an audible “click.” The audible click signals to the user that the wrench is turning in the unrestricted direction.

Alternatively, some wrenches employ a type of one-way freewheel clutch to provide one-way operation. This type of wrench may comprise a plurality of rollers placed in the space between the outer surface of a one-way freewheel clutch member having a through-hole for receiving an article to be turned and the inner surface of an outer box-end member. When the wrench turns in the restricted direction, the shape of the one-way freewheel clutch member promotes the wedging of the rollers between the one-way freewheel clutch member and the outer member, thereby essentially locking the two together. However, when turned in the unrestricted direction, the rollers will move along with the one-way freewheel clutch member along inside surface of the outer member. Unlike the ratcheting wrench, a one-way freewheel clutch wrench makes no audible sound when turning in the unrestricted direction. This may be problematic as there is no audible or tactile feedback from the wrench to know whether the wrench is “reloading” or just rotating along with the article being tightened or loosened.

One type of specialty wrench is a serpentine belt wrench. A serpentine belt is used in automobiles to snake around multiple pulleys. A belt tensioner or an idler pulley is used to guide and tension the serpentine belt. As belts wear, they require replacement. A serpentine belt wrench is used to loosen the belt tensioner. However, the belt tensioner can be positioned in tough to reach places.

### SUMMARY OF THE INVENTION

The present invention relates to a jointed wrench. A multi-directional knuckle in a midsection or handle of the wrench allows for multiple angles created in the handle of the wrench. This allows a user to manipulate a ratcheting portion of the wrench into otherwise inconvenient spaces, such as an interior of an automobile engine compartment.

In another aspect of the present invention, a locking ring is paired with a fine tooth wheel within a ratchet, and the locking ring couples with locking detented sockets or adaptors.

### BRIEF DESCRIPTION OF THE DRAWINGS

FIG. 1 is a perspective view of a jointed wrench according to the present invention.

FIG. 2 is an exploded view of the components of the jointed wrench of FIG. 1.

FIG. 3 is a top view the jointed wrench in a plurality of handle positions.

FIG. 3a is a close-up view of a plunger carried between adjacent teeth of a rotating spacer.

FIG. 4 is a perspective view of a front portion the jointed of FIG. 1 with a socket and a socket adaptor in position for coupling with the wrench.

FIG. 5 is a perspective view of the wrench of FIG. 1, showing socket engagement teeth and a socket locking ring.

FIG. 6 is a cross-sectional view of the socket engaging structure of the wrench.

FIG. 6a is a close-up view of a ring locking detent.

FIG. 6b is a close-up perspective view of a ring locking detent.

FIG. 7 is a perspective in-use view of the jointed wrench.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

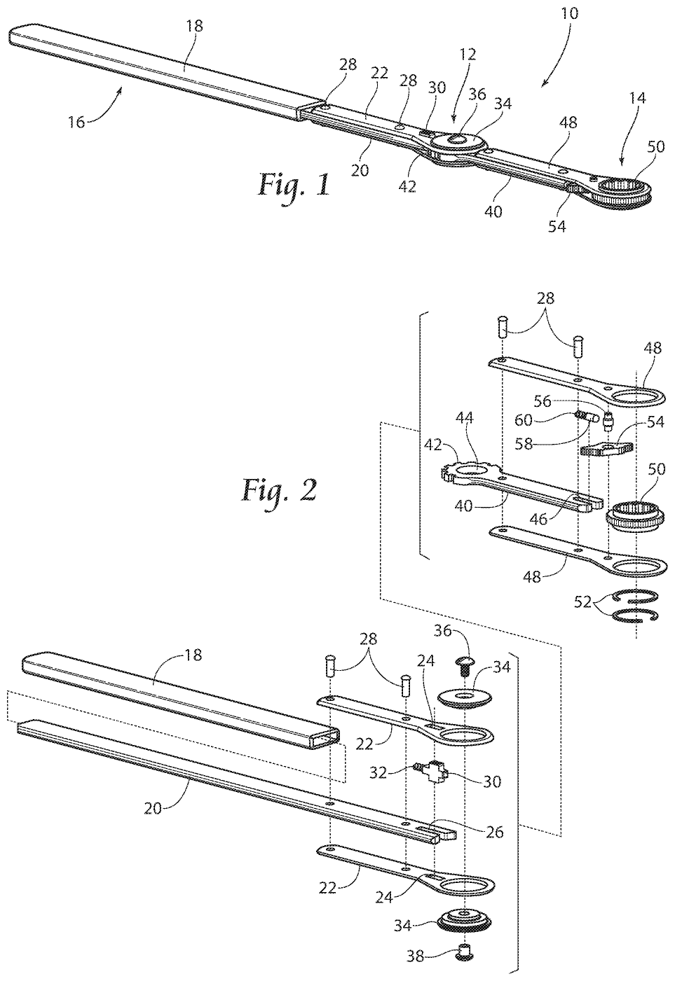

Referring now to FIG. 1, a perspective view of a jointed wrench 10 according to the present invention is shown. In general, the jointed wrench comprises a handle 16, a joint 12, and a ratchet 14. As will be described later, joint 12 allows the ratchet 14 to be placed into different angular positions relative to the handle 16, which facilitates use of the jointed wrench 10 in tight quarters. Details are shown in FIG. 2, which is an exploded view of the components of the jointed wrench 10 of FIG. 1.

Referring to FIGS. 1 and 2, a grip 18 is provided about a spacer bar 20. A pair of handles 22 are coupled to spacer bar 20 by rivets 28. A spacer bar slot 26 is provided at one end of spacer bar 20, and spacer bar 26 receives a plunger 30 and a plunger spring 32. Handle slots 24 provided on handles 22 are also configured to receive plunger 30.

Joint caps 34 couple a rotating spacer 40 with handles 22. Screw 36 and nut 38 couple together, in order, joint caps 34, handles 22, and rotating spacer 40.

A plurality of teeth 42 are positioned about one end of the rotating spacer bar 40. Plunger 30 is sized and configured to fit, at a distal end of plunger 30, into and between teeth 42.

A pair of handles 48 couple rotating spacer bar 40 with fine tooth pawl 54 which operates in conjunction with a fine tooth wheel 50. A plunger/46 receives pin plunger 58, carrying spring coil 60. A rivet shoulder 56 couples top handle 48, to fine tooth pawl 54 and the bottom handle 48.

Locking ring or rings 52 is/are carried by a retaining groove on one side of fine tooth wheel 50.

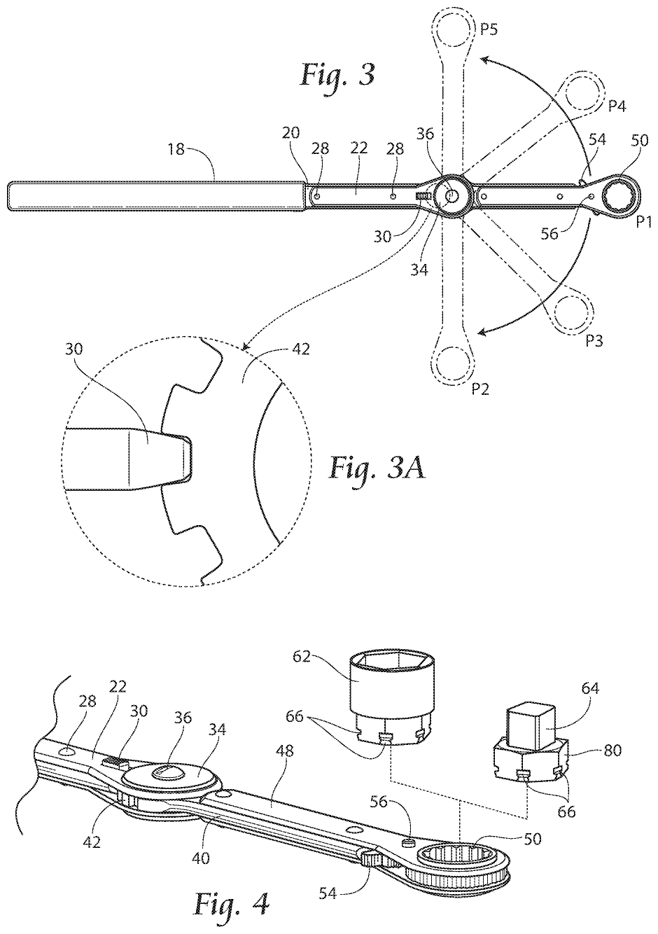

Referring now to FIG. 3 a top view the jointed wrench 10 is shown in a plurality of handle positions P1-P5. In order to change positions between P1-P5, a user manually engages plunger 30. By sliding plunger 30 distally and proximally, distal end of plunger 30 is removed from or engaged with teeth 42 of rotating spacer bar 40. A user can select positions P1-P5 by rotating rotating spacer bar 40 and disengaging plunger 30, setting the selected position. It is noted that although positions P1-P5 are shown, more or less positions can be provided by changing the number of teeth 42 carried by rotating spacer bar 40. The more teeth 42, the more available positions.

Fine tooth pawl 54 is switchable in positions to control whether fine tooth wheel 50 rotates freely in either the clockwise or counterclockwise direction.

Referring now to FIG. 3a, a closeup view plunger 30 is shown carried between adjacent teeth of rotating spacer 42. As can be seen, in a preferred embodiment, an angle between the teeth is slightly larger than an angle of a distal end of plunger 30.

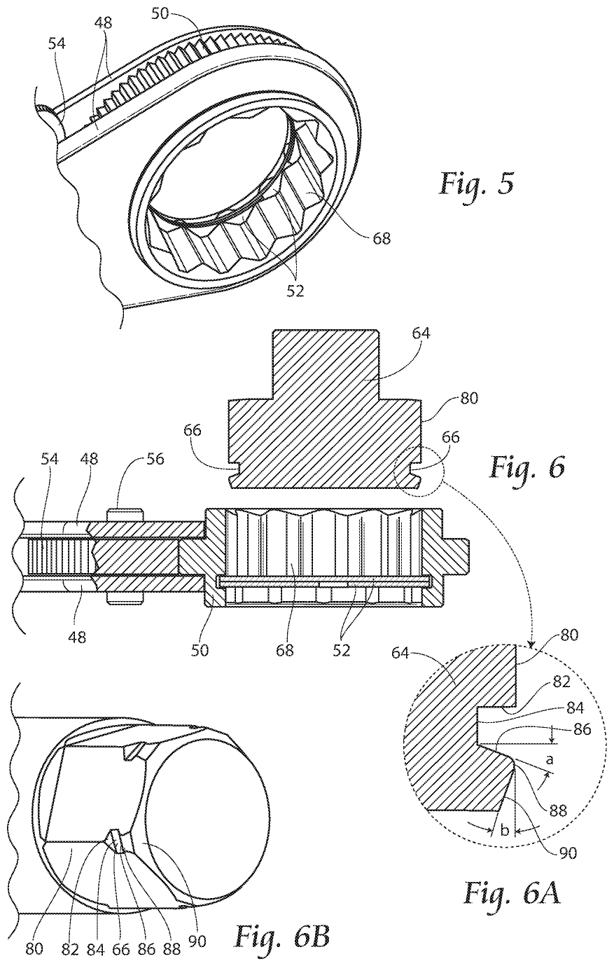

Referring now to FIG. 4, a perspective view of a front portion the jointed wrench 10 of FIG. 1 is shown. Socket 62 and a socket adaptor 64 are shown in position for coupling with the wrench. A series of locking ring locking detents 66 (shown in detail in FIGS. 6, 6a and 6b) are provided at planar intersections 80 of lower portions of each of the socket 62 and socket adaptor 64. Locking ring locking detents 66 selectively engage locking ring or rings 52 to secure either socket 62 or socket adaptor 64 into place within fine tooth wheel 50. Locking rings 52 are sized to snugly fit within locking detents 66.

Referring now to FIG. 5, socket engagement teeth 68 are provided in an interior of fine tooth wheel 50. In a preferred embodiment, socket engagement teeth 68 are provided more numerously than the number of sides of socket 62 or adaptor 64. Planar intersections 80 of socket 62 or adaptor 64 fit snugly between adjacent socket engagement teeth 68. An interior surface of socket locking ring 52 is sized to be exposed within adjacent socket engagement teeth 68.

Referring now to FIG. 6, a cross-sectional view of the socket engaging structure of the wrench is shown. Socket adaptor 64 is shown prepared for coupling. To couple either socket 62 or adaptor 64, planar intersections 80 are aligned between to fit between adjacent socket engagement teeth 68, and slid inwardly into the fine tooth wheel 50. Locking ring locking detents 66 then snap into engagement with ring 52.

Referring now to FIGS. 6a and 6b, close-up views ring locking detent 66 are shown. Ring locking detent 66 is configured to optimally grasp and release when desired, locking rings 52, which are preferably split ring or rings. Beginning with a vertical planar intersection 80, ring locking detent 66 preferably comprises a horizontal detent surface 82, a vertical detent surface 84, a horizontal sloped detent surface 86, a radius 88, and a vertical sloped detent surface 90. In a preferred embodiment, angles a and b are between 10° and 50°, in order to allow rings 52 to detent 66 under pressure, yet prevent rings 52 from unintentionally slipping out of engagement with detent 66.

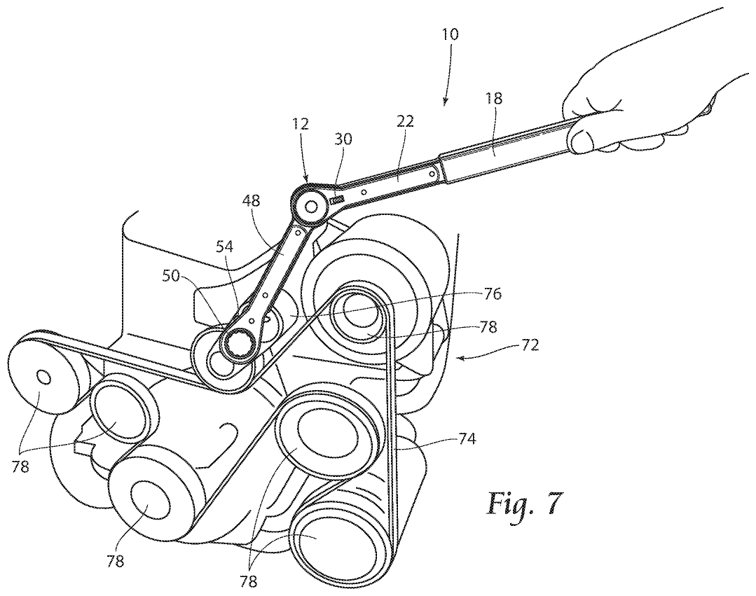

Referring now to FIG. 7, a perspective in-use view of the jointed wrench 10 is shown. In a typical engine compartment 72, a plurality of drive belt pulleys 78 carry and drive serpentine belt 74. In use, to change a serpentine belt 74, a user will engage serpentine belt wrench 10, and adjust joint 12 to the most advantageous position P1-P5 depending on configuration of components of the engine compartment 72. Socket 62, carried by fine tooth wheel 50 (not visible) engages a bolt (not shown) on belt tensioner 76, which can be loosened to remove belt 74, and then tightened to replace belt 74.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A jointed wrench comprising:
a spacer bar;
a proximal handle coupled to said spacer bar;
a plunger slidably coupled between said proximal handle and said spacer bar;
a rotating spacer comprising a plurality of teeth;
said plunger selectively positioned between two of said plurality of teeth;
a distal handle coupled to said rotating spacer;
a wrench coupled to said distal handle.

2. A jointed wrench according to claim 1, said wrench comprising a ratchet-ng mechanism.

3. A jointed wrench according to claim 1, said wrench comprising a locking ring coupled to a wheel.

4. A jointed wrench according to claim 3, said wrench comprising a socket comprising a plurality of detents coupled to said locking ring.
